(19) United States
(12) Patent Application Publication
(10) Pub. No.: US 2004/0134093 A1
(43) Pub. Date: Jul. 15, 2004

(54) Igniter and dryer therewith

(76) Inventor: In Hee Han, Changwon-si (KR)

Correspondence Address: MCKENNA LONG & ALDRIDGE LLP, Song K. Jung, 1900 K Street, N.W., Washington, DC, 20006, US

(21) Appl. No.: 10/703,670

(22) Filed: Nov. 10, 2003

(30) Foreign Application Priority Data
Jan. 14, 2003 (KR) P2003-0002457
Feb. 21, 2003 (KR) P2003-0011051

(51) Int. Cl. F26B 11/02

(52) U.S. Cl. 34/595

(57) ABSTRACT

An igniter having an igniter element, a bushing, adhesive and sealant is provided. The igniter element has a polarizing key for generating heat at a high temperature. The bushing is inserted on an outside of one end of the igniter element. The adhesive is placed in a bushing cavity for bonding the bushing with the igniter element. The sealant covers both the bushing and the adhesive placed in the cavity of the bushing thereby joining the bushing and adhesive and improving joining structures of components.

This application claims the benefit of Korean Patent Application Nos. P2003-0002457 filed on Jan. 14, 2003, and P2003-0011051 filed on Feb. 21, 2003, all of which are hereby incorporated by reference for all purposes as if full set forth herein.

### BACKGROUND OF THE INVENTION

1. Field of the Invention

The present invention relates to dryers, and more particularly, to a dryer having an improved igniter in a burner for generating heated air.

2. Background of the Related Art

In general, a dryer blows air heated by a heater into a drum for evaporating moisture from an object to be dried (“drying object”) in the drum to dry the drying object. There are exhaust type dryers and condensing type dryers and the method for disposing humid air generated during drying of the drying object determine the type.

An exhaust type dryer discharges humid air generated in the drum during drying of the drying object to the outside the dryer. The exhaust type dryer also introduces new dry air into the dryer, heats the new dry air and blows the new dry air into the drum.

A condensing type dryer removes moisture in humid air generated when a drying object in a drum is dried with heated air. The condensing type dryer also heats air again, and blows the air into a drum.

Both the exhaust type and condensing type dryers use heated air for drying a drying object in a drum. A burner generates heated air in the dryer. In general, the burner has a gas pipeline connected thereto, and gas injected through an injection nozzle may be ignited with an igniter. The ignited flame heats the air introduced into the air, thereby generating the heated air.

In general, the igniter in the burner has a component assembly fixed to a fixing bracket, and a component assembly for generating heat, which may be fabricated separately, assembled together, and mounted on the burner.

When two component assemblies are thus assembled together, easy and firm joining of the components assemblies is required for enhancing productivity and reducing a defective proportion.

Moreover, rotation of the drum and the like cause vibration of the dryer. As such, a part to which the igniter of the burner fastens weakens from the vibration when the dryer is used for an extended period, thereby causing defective operation. Thus, it is required that the fastened part be durable enough to withstand weakening and breakage.

### SUMMARY OF THE INVENTION

Accordingly, the present invention is directed to an igniter that substantially obviates one or more of the problems due to limitations and disadvantages of the related art.

An advantage of the present invention is to provide an igniter having an improved durability which can prevent separation or deformation of component assemblies in the igniter even if vibration is given thereto for a long time. Thus, the present invention prevents defective operation and an out of order condition.

Another advantage of the present invention is to improve ease of assembly during fabrication of the igniter.

A further advantage of the present invention is to provide a dryer in which malfunction or nonfunctioning condition of the burner is prevented as a durability of the igniter is improved.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these advantages and other advantages and in accordance with the purpose of the present invention, as embodied and broadly described herein, the igniter includes an igniter element having a polarizing key for generating heat at a high temperature. The igniter also has a bushing inserted on an outside of one end of the igniter element, adhesive placed in a cavity of the bushing for bonding the bushing with the one end of the igniter element, and sealant covering both the bushing and the adhesive placed in the cavity of the bushing for joining the bushing and adhesive.

In another aspect of the present invention, there is provided an igniter including an igniter element having a polarizing key for generating heat at a high temperature, a bushing inserted on an outside of an end of the igniter element, the bushing having means for preventing adhesive from moving along a length direction to increase a joining force with the adhesive, and adhesive placed in a cavity of the bushing for bonding the bushing with the one end of the igniter element.

In a further aspect of the present invention, there is provided an igniter including an igniter element having a polarizing key for generating heat at a high temperature and a bushing inserted on an outside of one end of the igniter element. The igniter also includes adhesive placed in a cavity of the bushing for bonding the bushing with the one end of the igniter element, and means for preventing the igniter element from moving in a length direction with respect to the bushing.

In a still further aspect of the present invention, there is provided a dryer including a cabinet, a drum rotatably mounted in the cabinet for holding a drying object, and a burner inside of the cabinet for generating heated air, including an igniter for igniting fuel supplied from an exterior. The igniter also includes an igniter element having a polarizing key for generating heat at a high temperature, a bushing inserted on an outside of one end of the igniter element, adhesive placed in a cavity of the bushing for bonding the bushing with the one end of the igniter element, and sealant covering both the bushing and the adhesive placed in the cavity of the bushing for joining the bushing and adhesive.

The igniter element includes a cylindrical hollow first body having straight slots extending in a length direction, and a second body extending in a length direction from the first body part where the second body has helical bands formed along a length direction of the second body starting from the slots. The igniter element also includes a polarizing key inserted in the first and second bodies, the polarizing key has a lead line connected thereto. The first and second bodies are formed of non-metallic resistant material, such as silicon carbide.

The polarizing key includes a large width part of a plate in the first body having a part exposed to an exterior through the slots, and a small width part in the second body extending from the large width part.

The igniter may further include a bracket fastened to an outside surface of the bushing.

The sealant may be selected from silicone, epoxy, and EMC (Epoxy Molding Compound). The adhesive may also be ceramic cement.

The sealant is coated on a side of the bushing opposite to a side which contacts the igniter element thereby covering both the adhesive and the bushing. The sealant is coated on a side of the bushing the igniter element in order to cover both the bushing and an area of an outside circumferential surface of the igniter element. The adhesive may be placed in part of the cavity of the bushing, and the sealant is placed in a remainder of the cavity. Alternatively, the adhesive may be placed in substantially one half of the cavity, and the sealant may be placed in a remainder of the cavity.

The means provided to the bushing for preventing the adhesive from moving in a length direction of the bushing may be an uneven surface formed in an inside circumferential surface of the bushing. The uneven surface may be a dimple, or a lattice. In addition, the means may be a flange extending inward from the bushing. The flange may be formed at a side of the bushing opposite to a side of the bushing which contacts the igniter element.

The means for preventing the adhesive from moving in a length direction with respect to the bushing may include key slots in an outside surface of the polarizing key, and a snap ring inserted on an outside circumference of the igniter element so as to be inserted in the key slots in contact with the bushing thereby preventing the igniter element from moving toward the bushing. The snap ring may be formed of a non-metallic material.

The means for preventing the adhesive from moving in a length direction with respect to the bushing may include a stopper flange on the bushing which projects inward from a side of the bushing which contacts the igniter, guide slots in the stopper flange which guide opposite side surfaces of the polarizing key when the bushing is inserted in the igniter element, and bushing stopper slots which receive the stopper flange to limit a length direction movement of the bushing and the igniter element when the bushing is turned after the igniter element is inserted in the bushing.

The means for preventing the adhesive from moving in a length direction with respect to the bushing may further include a stopper projection for limiting a rotation angle of the bushing when the bushing is rotated as the stopper flange is inserted in the bushing stopper slots. The means may include a female thread formed in an outside circumferential surface of the polarizing key, and a male thread on an inside circumferential surface of the bushing for engaging with the female thread in the polarizing key.

The means for preventing the adhesive from moving in a length direction with respect to the bushing may include a step on an inside circumferential surface of the bushing, and a step on an outside circumferential surface of the polarizing key so as to be engaged with the step on the bushing for preventing the igniter element from moving in any length direction.

The bushing is fastened to the igniter element as the bushing is inserted from a fore end of the igniter element to a rear end of the igniter element to which a lead line is connected. The step on the bushing is formed at a boundary surface between a small diameter part formed on an inside circumferential surface of the bushing at a side of the bushing at a rear end of the igniter element that is in direct contact with the bushing, and a large diameter part formed on the inside circumferential surface of the bushing so as to be in contact with the small diameter part. The step on the polarizing key is formed at a boundary surface between a first large width part in contact with the small diameter part at the rear end side of the igniter element and a second large width part on the outside circumferential surface of the polarizing key so as to be in contact with the large diameter part.

The bushing is inserted from a rear end of the igniter element to a fore end of the igniter element. The step on the bushing is formed at a boundary surface between a large diameter part formed on an inside circumferential surface of the bushing at a side of the bushing which is in direct contact with a rear end of the igniter element, and a small diameter part formed on the inside circumferential surface of the bushing so as to be in contact with the small diameter part. The step on the polarizing key is formed at a boundary surface between a second large width part in contact with the large diameter part at rear end side of the igniter element and the first large width part on the outside circumferential surface of the polarizing key so as to be in contact with the small diameter part.

It is to be understood that both the foregoing description and the following detailed description of the present invention are exemplary and explanatory and are intended to provide further explanation of the claimed invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a disassembled perspective view of a dryer in accordance with a preferred embodiment of the present invention;

FIG. 2 illustrates a plan view of a structure of the burner in FIG. 1;

FIG. 3 illustrates a perspective view of a structure of the igniter in FIG. 2;

FIGS. 4A-4D illustrate the steps of a method for fabricating the igniter in FIG. 3, wherein

FIG. 4A illustrates a front view of a bushing having a bracket fastened thereto prior to insertion in an igniter element;

FIG. 4B illustrates a front view showing a state after assembly of FIG. 4A;

FIG. 4C illustrates a section of FIG. 4B;

FIG. 4D illustrates an inside of a bushing filled with adhesive; and

FIG. 4E illustrates a section of a heat generating part of an igniter;

FIGS. 5A-5D illustrate front views and perspective views of examples of igniters;

FIG. 6 illustrates a perspective view of an improved igniter in accordance with a first preferred embodiment of the present invention;

FIG. 7 illustrates a front view of FIG. 6;

FIG. 8 illustrates a perspective view of an improved igniter in accordance with a second embodiment of the present invention;

FIG. 9 illustrates a front view of an improved igniter in accordance with a third embodiment of the present invention;

FIG. 10 illustrates a front view of an improved igniter in accordance with a fourth embodiment of the present invention;

FIG. 11 illustrates a front view of an improved igniter in accordance with a fifth embodiment of the present invention;

FIG. 12 illustrates a perspective view of an improved igniter in accordance with a sixth embodiment of the present invention;

FIG. 13 illustrates a perspective view of an improved igniter in accordance with a seventh embodiment of the present invention;

FIG. 14 illustrates a disassembled perspective view of an improved igniter in accordance with an eighth embodiment of the present invention;

FIG. 15 illustrates a front view of an improved igniter in accordance with a ninth embodiment of the present invention;

FIG. 16 illustrates a front view of an improved igniter in accordance with a tenth embodiment of the present invention;

FIG. 17 illustrates a section view of an improved igniter in accordance with an eleventh embodiment of the present invention; and

FIG. 18 illustrates a section view of an improved igniter in accordance with a twelfth embodiment of the present invention.

### DETAILED DESCRIPTION OF THE ILLUSTRATED EMBODIMENTS

Reference will now be made in detail to the embodiments of the present invention, examples of which are illustrated in the accompanying drawings. In describing the embodiments, same parts will be given the same names and reference symbols, and repetitive description will be omitted.

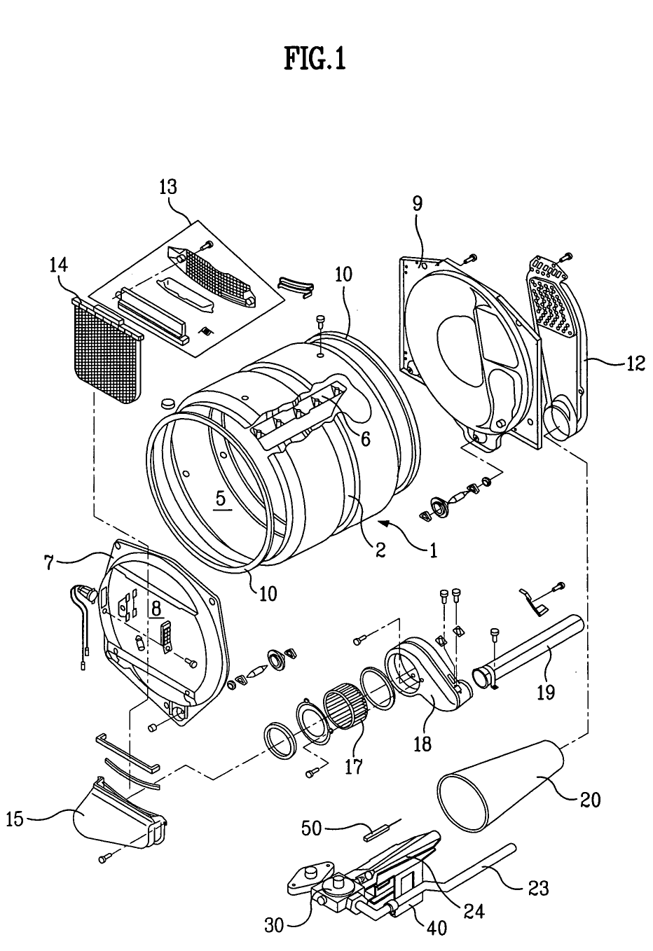

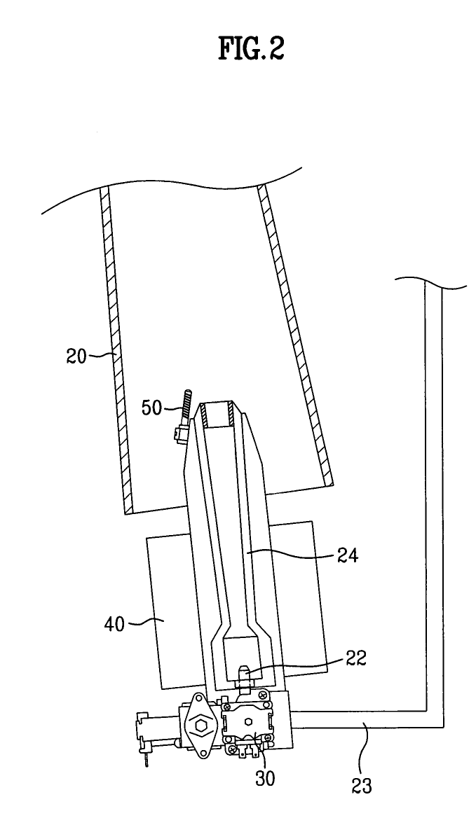

FIG. 1 illustrates a disassembled perspective view showing a dryer in accordance with a first embodiment of the present invention, and FIG. 2 illustrates a plan view showing a structure of the burner in FIG. 1.

Referring to FIGS. 1 and 2, there is a drum 1 rotatably mounted inside of a cabinet 100 that forms an outer appearance of the dryer. The drum 1, which is cylindrical overall, includes opened front and rear parts, and a belt groove 2 formed along an outside circumferential surface for winding a belt (not shown) thereon driven by a separate driving source, for example, a motor.

The drum 1 has a drying chamber 5 formed therein, with a plurality of lifts 6 for lifting up and dropping down a drying object in the drying chamber 5 to improve a drying efficiency by turning the drying object upside down.

The dryer also includes a front panel 7 and a rear panel 9 each located at a fore end and a rear end of the drum, oppositely. The front panel 7 and the rear panel 9 close a front and a rear of the drum 1 to form the drying chamber 5.

Additionally, the dryer has sealers 10 between the front panel 7 and the rotating drum 1, and the rear panel 9 and the rotating drum 1, for preventing leakage.

A plurality of rollers (not shown) are on the front panel 7 and the rear panel 9 for supporting opposite front and rear parts of the drum 1.

The dryer also has an opening 8 in the front panel 7 for allowing communication between the drying chamber 5 and an exterior. The opening 8 is opened/closed by a door (not shown).

A heated air supplying duct 12 mounts on the rear panel 9 in communication with the drying chamber 5 which serves as a passage for supplying heated air to the drying chamber 5.

An air exhaust grill assembly 13 disposed in a lower part of the opening 8 in the front panel 7 allows for the escaping of air from the drying chamber 5.

A lint filter 14 mounts together with the air exhaust grill assembly 13. The lint filter 14 filters foreign matter (for example, waste thread, or dust) mixed with the air escaping from the drying chamber 5.

A lint duct 15 communicates with the air exhaust grill assembly 13, and the lint filter 14 extends into the lint duct 15. A blower 17 connects to the lint duct 15 for drawing out air from the drying chamber 5 through the lint duct 15. The blower 17 is provided inside a blower housing 18.

The blower housing 18 has one side in communication with the lint duct 15 and the other side connects to an exhaust pipe 19. Therefore, air escaping from the drying chamber 5 and passing through the lint duct 15 discharges to an exterior through the exhaust pipe 19 by blowing action of the blower 17.

Furthermore, a guide funnel 20 connects to an inlet of the heated air supplying duct 12. The guide funnel 20 guides heated air, generated as gas burns, toward the inlet of the heated air supplying duct 12.

A mixing pipe 24 positioned at an inlet of the guide funnel 20 mixes gas injected from a gas nozzle 22 and primary air.

The mixing pipe 24 is fixed to a top surface of a burner support 40 which is fixed to a floor of the cabinet. An igniter 50 fastens to one side of the burner support 40 with fastening members, such as screws, for igniting the mixed gas from the mixing pipe 24.

The burner support 40 has a front side higher than a rear side to form a slope which positions an outlet side of the mixing pipe 24 fixed to an upper surface of the burner support 40 higher than an inlet side thereof. As such, an axis direction of the mixing pipe is the same as a direction of a flame advance.

Referring to FIG. 2, the outlet of the mixing tube 24 is positioned a distance inside of the guide funnel 20 from the inlet of the guide funnel 20.

The gas nozzle 22 is correspondingly mounted in the inlet of the mixing tube 24. The gas nozzle 22 has a valve 30 for supplying and controlling a supply rate of gas.

A gas pipe 23 connects to the valve 30 for continuously supplying gas from a separate gas source.

Accordingly, gas injected from the gas nozzle 22 and external air, primary air, from the inlet of the mixing pipe 24 are mixed inside the mixing tube 24.

The drying operation of the dryer will be described.

After introducing a drying object (for an example, wet laundry) into the drying chamber 5 in the drum 1 and closing the door, an operation button is pressed for operating the dryer. When operation begins, the belt around the belt groove 2 is driven by another driving source thereby rotating the drum 1.

As the blower 17 begins operation, air is drawn from the drying chamber 5 through the lint duct 15.

Then, external air is introduced into the drying chamber 5 through the heated air supplying duct 12 due to a pressure difference. In this instance, the air supplied to the heated air supplying duct 12 is heated by the gas burning device and has a relatively high temperature.

To further illustrate, gas is injected into the mixing pipe 24 through the gas nozzle 22, and the primary air is introduced into the inlet of the mixing pipe 24. The gas and the primary air are mixed inside the mixing pipe 24, ignited by a heated igniter 50 at the outlet of the mixing tube 24, and burned. A thermal energy generated as the gas burns thus is introduced into the guide funnel 20 and heats the air to generate the heated air.

The heated air is then introduced into the drying chamber 5 in the drum 1 through the heated air supplying duct 12.

After absorbing moisture from laundry in the drying chamber 5, the heated air escapes from the drying chamber 5 through the air discharge grill assembly 13 by a suction force of the blower 17.

Foreign matters, such as dust and waste thread in the air passing through the air discharge grill assembly 13, are filtered as the air passes through the lint filter 14.

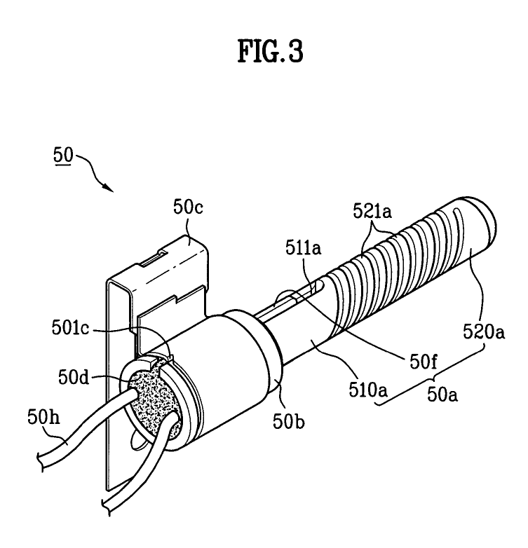

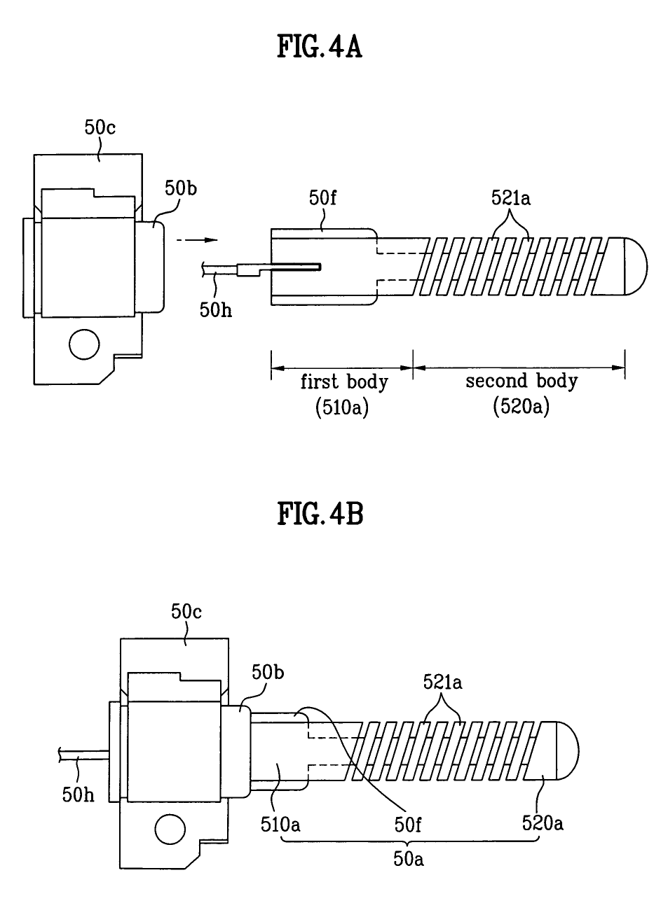

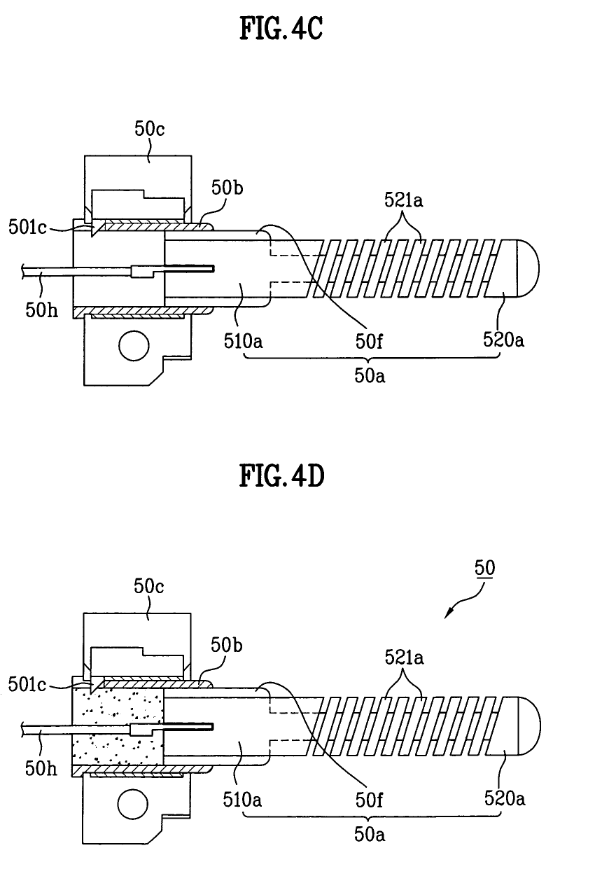

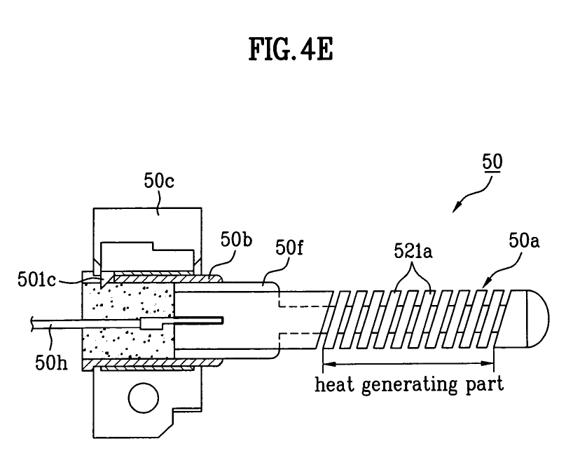

An igniter applicable to the dryer of the present invention and a method for fabricating the same will be described in detail with reference to FIGS. 3 and 4.

The igniter element 50a is formed of a non-metallic resistant material, such as silicon carbide SiC, and includes first and second bodies 510a and 520a of hollow cylinders, and a polarizing key 50f.

The first body 510a has two straight slots 511a formed in an outside circumferential surface, and the second body 520a extends in a length direction from the first body 510a. The slots 511a are formed in opposite sides of the first body 510a. The second body 520a has helical bands 521a formed along a length direction of the second body 520a starting from the two slots 511a. A coat of nickel is on an outside circumference of the first body 510a of the igniter element 50a for improving conductivity.

Referring to FIGS. 4A-4D, the polarizing key 50f is positioned inside of the first and second bodies 510a and 520a, and a portion of which is exposed through the slots 511a in the first body 510a. A lead line 50h is connected to the polarizing key 50f. The polarizing key 50f is heated to a high temperature when power is provided thereto through the lead line 50h.

A bushing 50b is inserted to an outside of the first body part 510a. A bracket 50c is fixed to an outside circumference to the bushing 50b, and the bracket 50c is fastened to the burner support 40. A wedge piece 501c is positioned inside the bushing 50b through a notch in the bushing 50b at one side of the bracket 50c. Adhesive 50d is filled inside of the bushing 50b for fixing the bushing 50b to the first body 510a of the igniter element 50a.

A method for fabricating the igniter 50 will now be described.

Referring to FIG. 4A, an igniter element 50a having a polarizing key 50f provided inside of the first and second bodies 510a and 520a is provided. Additionally, the bushing 50b is fastened to the bracket 50c. Then, as shown in FIG. 4B, the lead line 50h is put through an inside of the bushing 50b, and the bushing 50b, having the bracket 50c fastened thereto, is inserted to a rear end of the igniter element 50a.

In this state, as shown in a front sectional view of FIG. 4C, the bushing 50b has a cavity.

Next, when the bushing 50b is set in a position on the igniter element 50a, a paste of an adhesive 50d is placed into the bushing 50b through a first body 510a side of the igniter element 50a (i.e., a rear end side) (see FIG. 4D).

Then, as the adhesive 50d sets, the wedge piece 501c, which is formed as one side of the bracket 50c is cut and bent inward so as to be positioned inside of the bushing 50b through a notch in the bushing 50b, is buried and fixed. As such, the bushing 50b is fixed to the bracket 50c and the bushing 50b maintains a joined state with the igniter element 50a.

When the adhesive 50d is placed in the bushing 50b, the bushing 50b is placed into an oven (not shown) for joining the bracket 50c and the adhesive 50d by setting the adhesive 50d with the wedge piece 501c which is buried therein.

Then, a terminal block (not shown) is joined at an end of the lead line 50h.

Referring to FIG. 4E, when the igniter 50 is provided with power, the polarizing key 50f in the helical band 521a is heated to a high temperature.

However, the foregoing igniter and a dryer have the following problems.

During fabrication of the igniter 50, before inserting the bushing 50b having the bracket 50c fastened thereto to the outside circumference of the igniter element 50a, and placing the adhesive 50d in an inside of the bushing 50b, positioning of the bushing 50b on the igniter element 50a may be required, for which an additional jig (not shown) is required.

Without the additional jig, positioning of the bushing 50b on the igniter element 50a may not be possible, thus, the position of the bushing changes along a length direction of the igniter element 50a, causing difficulty in placeing the adhesive 50d, and resulting in difficulty in progressing a process for joining the bushing 50b and the igniter element 50a. Since the jig is required for solving the difficulty, production costs rise, and the fabrication process becomes complicated.

Particularly, in addition to the problems in fabrication of the igniter 50, the igniter causes the following problems when the igniter is applied to products, such as dryer, and the like.

System vibration, which occurs as the drum driving motor or blower is driven, is transmitted to the burner support 40, and the vibration of the burner support 40 is in turn transmitted to the igniter 50 fastened thereto, causing vibration of the igniter 50.

Although the bushing 50b of the igniter 50 is fastened to the bracket firmly, the adhesive 50d in the bushing 50b is sensitive to an impact, such that a holding force of the adhesive 50d to the wedge piece 501c drops gradually due to the vibration.

The vibration of the bracket 50c caused by the system vibration makes the wedge piece 501c of metal buried in the adhesive 50d wear down or damage a part of the adhesive in contact with the wedge piece 501c, thereby loosening the joined state of the bracket 50c and the adhesive 50d.

When the bushing 50b loosens fully from the adhesive 50d as the system vibration is repeated, the igniter element 50a bonded with the adhesive 50d displaces relative to the bushing 50b.

Particularly, as described before, since the front side of the burner support 40 is higher than the rear side, such that the mixing pipe fixed to the upper surface of the burner support 40 and the igniter 50 fastened to the burner support 40 are sloped, the igniter element 50a gradually slips backward with respect to the bushing 50b, and breaks away from a proper position.

Thus, when a bonding force between the bushing 50b and the adhesive 50d in the igniter 50 drops due to system vibration, a relative displacement of the igniter element 50a with respect to the bushing 50b takes place, resulting in break away of the igniter element 50a from a proper position of the inlet of the mixing pipe, thereby causing ignition failure during starting of the dryer.

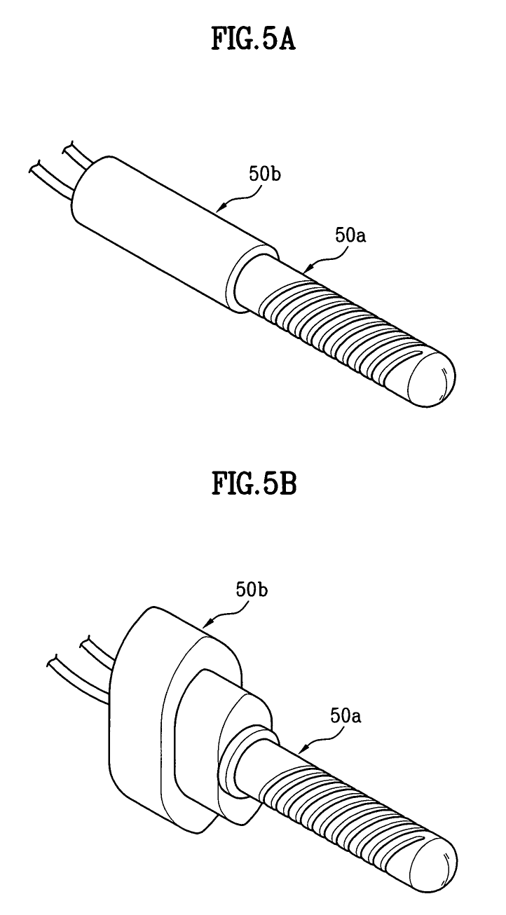

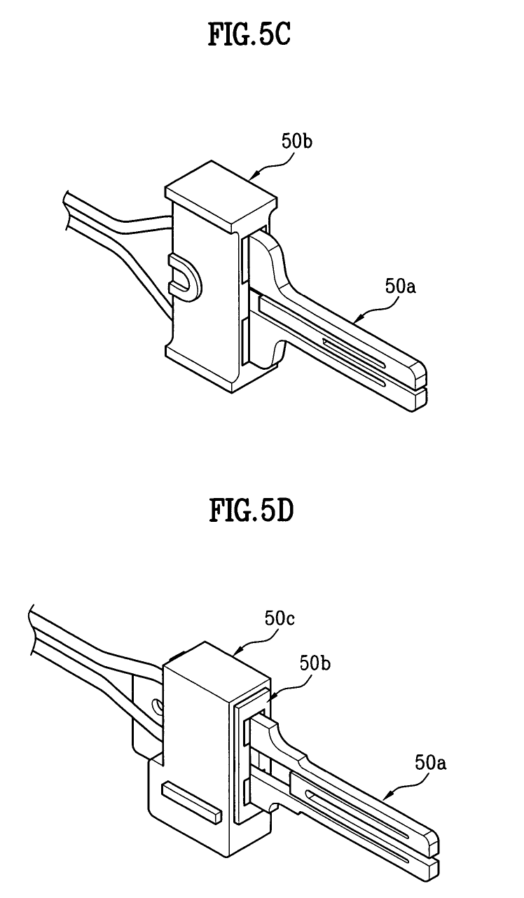

Moreover, the igniters in FIGS. 5A-5D have the problem related to break away of the bushing 50b and the igniter element.

Even though the igniter may not be a type where the bracket 50c is fixed to the bushing 50b, when vibration is transmitted to the bushing 50b continuously where the igniter 50 is fixed to a system by additional means, the bonding force between the bushing 50b and the igniter 50a drops.

Accordingly, the present invention provides an igniter having an improved structure that can solve the foregoing problem. The embodiments will be described with reference to the attached drawings in detail. In describing the embodiments, parts the same as the foregoing parts will be given the same names and reference symbols.

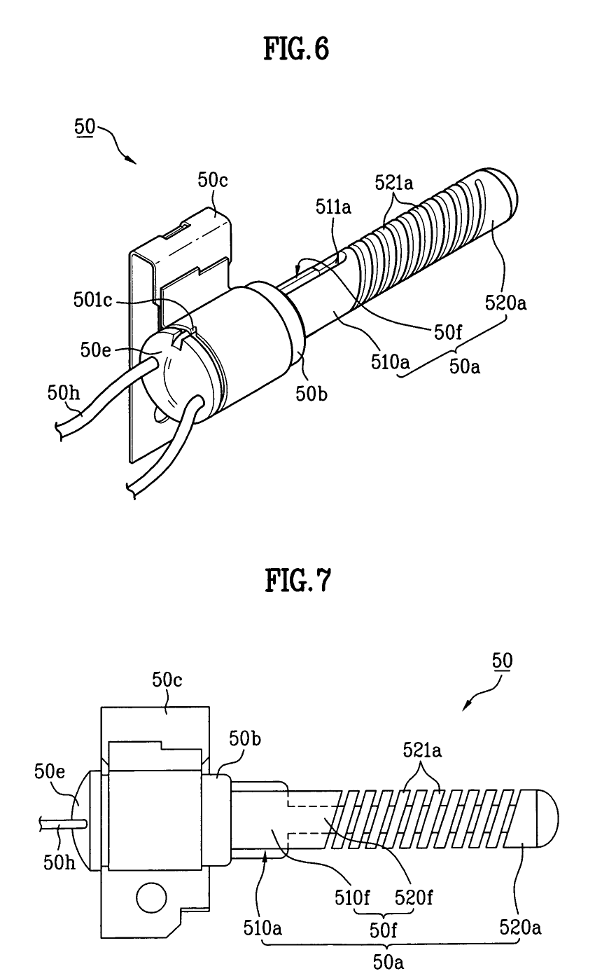

FIG. 6 illustrates a perspective view of an improved igniter in accordance with a first embodiment of the present invention, and FIG. 7 illustrates a front view of FIG. 6, the igniter 50 in accordance with the first embodiment of the present invention will now be described.

The igniter element 50a includes first and second bodies 510a and 520a, and a polarizing key 50f.

The first or second bodies 510a and 520a is long and hollow, and formed of non-metallic resistant material, such as silicon carbide. As shown in FIG. 6, there are straight slots 511a in opposite sides of an outside surface of the first body 510a. Also as shown in FIG. 6, the second body 520a extends from the first body 510a in a length direction. The second body 520a has helical bands 521a extending in a helical form along the length direction of the second body 520a starting from the slots 511a. A coat of nickel is applied to an outside circumference of the first body 510a of the igniter element 50a for improving conductivity.

The polarizing key 50f, which may be a plate form, is positioned inside the first and second bodies 510a and 520a, and, as shown in FIG. 6, a portion of the polarizing key 50f is exposed through the slots 511a in the first body 510a.

The polarizing key 50f has a large width part 510f and a small width part 520f. As shown in FIG. 7, both sides of the large width part 510 are exposed to the exterior through the slots 511a in the first body 510a. Also as shown in FIG. 7, the small width part 520f extends from the large width part 510f into an inside of the helical bands 521a of the second body 520a.

A lead line 50h connects to the polarizing key 50f. The small width part 520f inside of the helical bands 521a heats to a high temperature when a power is provided to the polarizing key 50f through the lead line 50h.

Referring to FIG. 6, a bushing 50b is placed over a portion of the first body part 510a of the igniter element 50a. A bracket 50c is fixed to an outside circumference of the bushing 50b, and the bracket 50c is fastened to a fastening part, such as a burner support 40. At one side of the bracket 50c, there is a wedge piece 501c positioned inside the bushing 50b through a notch in the bushing 50b. Additionally, adhesive 50d (not shown) is placed inside of the bushing 50b for bonding the bushing 50b to the first body 510a of the igniter element 50a. The adhesive may be a ceramic cement having a strong insulating strength.

Sealant 50e is coated on and covers both the adhesive and the bushing 50b opposite to a side of the bushing 50b which is in contact with the first body 510a in which the adhesive is injected therethrough. Examples of the sealant 50e which may be used include silicone or epoxy resin, EMC (Epoxy Molding Compound), or the like. The sealant 50e is not limited thereto, as any material having a bonding force and heat resistance may be used.

The action of the igniter 50 in accordance with a first embodiment of the present invention will be described when the igniter 50 is applied to a product, such as a dryer.

During operation of a dryer, system vibration, which takes place as the drum driving motor or blower is driven, is transmitted to the burner support 40, and the vibration of the burner support 40 is in turn transmitted to the igniter 50 fastened thereto, making the igniter 50 vibrate.

The firm fastening of the bushing 50b to the bracket 50c and the bonding of the bushing 50b with the adhesive with sealant 50e, such as silicone, which maintains a fastened state, does not allow the vibration to affect the bonding force between the bushing 50b and the adhesive 50d even if the vibration is transmitted to the bracket 50c.

If the system vibration is transmitted to the bracket 50c, the bonding force between the bushing 50b and the adhesive 50d is not reduced by a gripping force of the sealant 50e, thereby preventing the igniter element 50a from falling off the adhesive 50d.

As described before with reference to FIGS. 1 and 2, since the front side of the burner support 40 is higher than the rear side such that the mixing pipe fixed to the upper surface of the burner support 40 and the igniter 50 are sloped, it is possible that the igniter element 50a may gradually slip backward with respect to the bushing 50b and break away from a proper position. The sealant 50e is coated on a side of the bushing 50b on which the adhesive is injected therethrough, thus gripping the adhesive and the bushing at the same time. As such, break away of the igniter element 50a is prevented.

Other embodiments of the present invention will be described in succession. In describing the embodiment, description of parts which are the same as those discussed with reference to the first embodiment will be omitted.

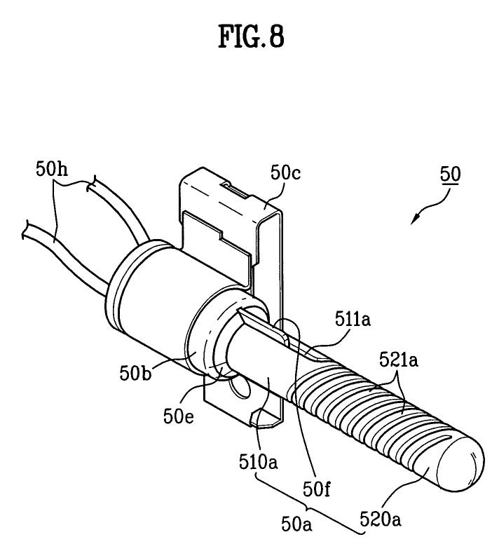

FIG. 8 illustrates a perspective view of an improved igniter 50 in accordance with a second embodiment of the present invention having a system such as the embodiment described with reference to FIGS. 6 and 7. As shown in FIG. 8, the sealant 50e, such as silicone or the like, is coated on a side of the bushing 50b opposite to a side of the bushing 50b where adhesive is injected therethrough, i.e., on a side in direct contact with the first body 510a. The sealant 50e covers both the bushing 50b and a part of an outside circumferential surface of the igniter element 50a.

According to the second embodiment of the present invention, as the sealant 50e is coated on a side of the bushing 50b opposite the side the adhesive is injected therethrough, the sealant 50e grips the adhesive 50d and the bushing 50b at the same time. Thus, break away of the igniter element 50a can be effectively prevented when vibration of the system is transmitted to the igniter 50.

Moreover, if the igniter 50 is mounted horizontally, or the front of the igniter (a side of the second body) is lower than a rear side of the igniter (a side of the first body), the break away of the igniter element 50a is prevented.

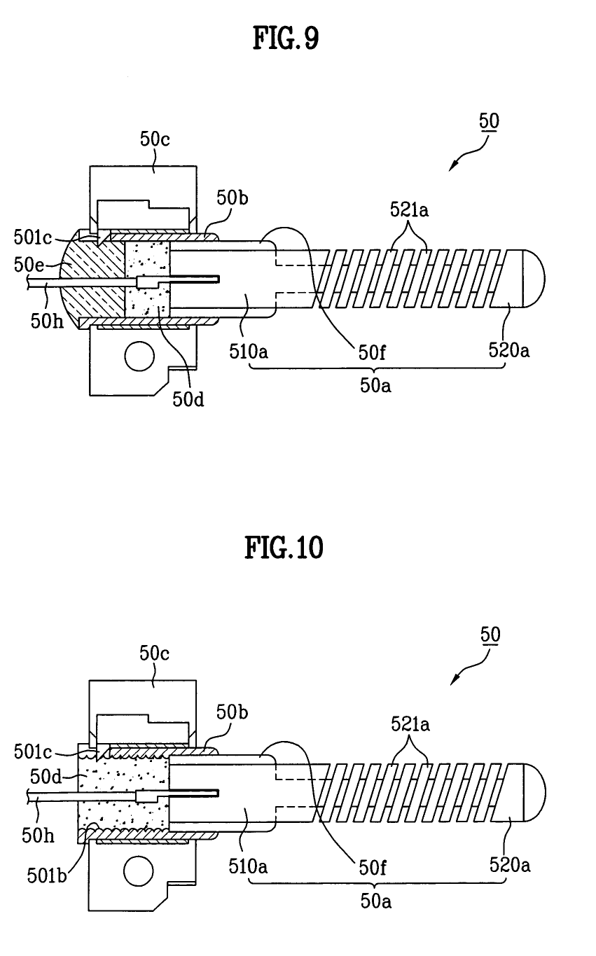

FIG. 9 illustrates a front view, of an improved igniter in accordance with a third embodiment of the present invention.

The igniter 50 in accordance with the third embodiment of the present invention includes adhesive 50d placed in a portion of a cavity of the bushing 50b, and sealant 50e, such as silicone, placed in a remainder of the cavity.

In an embodiment, the adhesive 50d is placed substantially in one half of the cavity of the bushing 50b, and the sealant 50e is placed in a remainder of the cavity.

In this case, the joining force between the bushing 50b and the adhesive 50d becomes greater due to a bonding force of the sealant following an increase of the sealant 50e. Therefore, this embodiment more effectively prevents break away of the igniter element 50a if the front side of the igniter 50 is higher than the rear side.

Furthermore, as will be discussed in greater detail later on, changing a structure of the bushing of an igniter, or changing both the structures of the bushing and the polarizing key of an igniter, the igniter (see FIGS. 10-14) provides a structure that prevents break away of components of the igniter without using the sealant 50e.

FIG. 10 illustrates a front view of an improved igniter in accordance with a fourth embodiment of the present invention. As shown in FIG. 10, the igniter 50 includes an uneven surface 501b along an axis direction of an inside circumferential surface of the bushing 50b.

Referring to FIG. 10, the uneven surface 501b of the inside circumferential surface of the bushing may be in the form of dimples, or, though not shown, a lattice form. However, the uneven surface is not limited to the above, and the uneven surface may be any form which causes interference between the element thereby increasing a contact area to prevent break away between elements, such as dot formed projections from the inside circumferential surface of the bushing 50b.

According to the fourth embodiment of the present invention, during fabrication of the igniter 50, the adhesive 50d is injected inside the bushing 50b when the bushing 50b is inserted about the first body 510a of the igniter element 50a. The igniter element 50a and the bushing 50b are joined as the adhesive 50d sets. According to the fourth embodiment of the present invention, if system vibration occurs when the igniter 50 is mounted with a slope in a dryer having the igniter 50, the uneven surface 501b prevents the adhesive 50d from slipping backward. Thus, break away of the igniter element 50a joined with the adhesive 50d from the bushing 50b is prevented.

The joining force between the uneven surface 501b on the inside circumferential surface of the bushing 50b and the adhesive 50d injected into the inside of the bushing which sets such that the adhesive 50d complements the uneven surface on the inside circumferential surface of the bushing prevents break away of the components from each other.

Next, FIG. 11 illustrates a front view, of an improved igniter in accordance with a fifth embodiment of the present invention. As shown, the igniter 50 includes a flange 502b projecting inward of the bushing 50b from an end thereof inserted about an outside of the first body 510a of the igniter element 50a.

According to the fifth embodiment of the present invention, as system vibration occurs when the igniter 50 is mounted with a slope in a dryer having the igniter 50 of the fifth embodiment applied thereto, the flange 502b is a stopper which prevents the adhesive 50d from slipping backward. Therefore, break away of the igniter element 50a joined with the adhesive 50d from the bushing 50b is prevented.

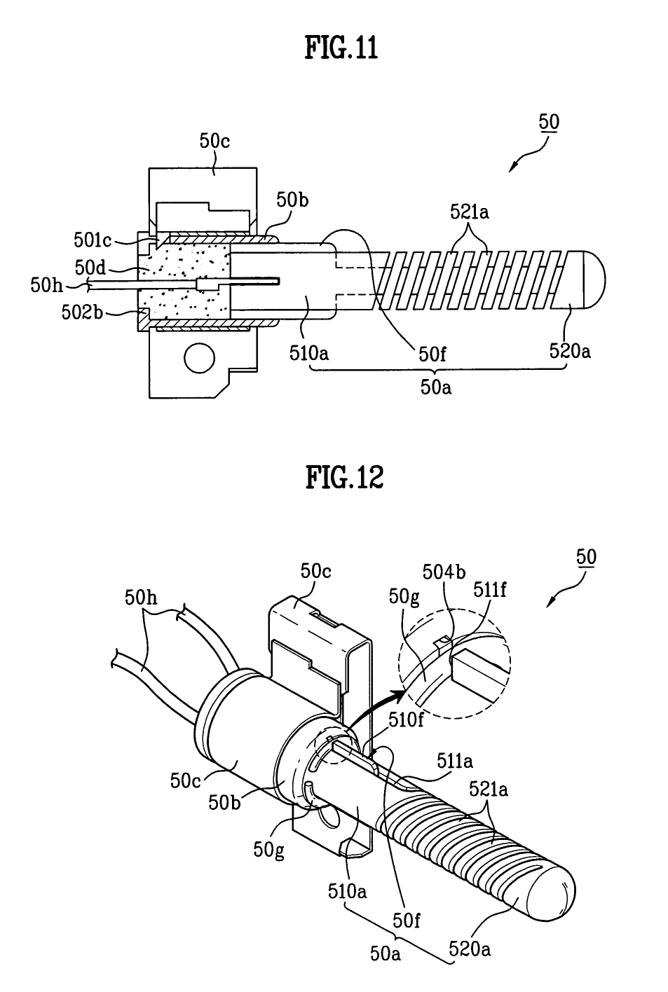

FIG. 12 illustrates a perspective view of an improved igniter in accordance with a sixth embodiment of the present invention. Referring to FIG. 12, the large width part 510f of the polarizing key 50f has a key slot 511f. A snap ring 50g formed with a non-conductive material is mounted in the key slot 511f for preventing displacement of the polarizing key 50f with respect to the bushing 50b, thereby preventing break away of the igniter element 50a.

According to the sixth embodiment of the present invention, if system vibration occurs when the igniter 50 is mounted with a slope such that a front side is higher than a rear side in a dryer having the igniter 50, the snap ring 50g, which is positioned in the key slot 511f in the polarizing key 50f joined with the adhesive 50d, is a stopper which prevents the polarizing key 50f and the adhesive 50d joined thereto from slipping backward. Thus, the break away of the igniter element 50a joined with the adhesive 50d from the bushing 50b is prevented.

The snap ring 50g may be replaced with a washer having a cut out portion so as to have elasticity.

The sixth embodiment prevents break away of the igniter element 50a from the bushing 50b regardless of the sloped or horizontal mounting of the igniter 50 when applying the igniter 50 to a dryer or the like.

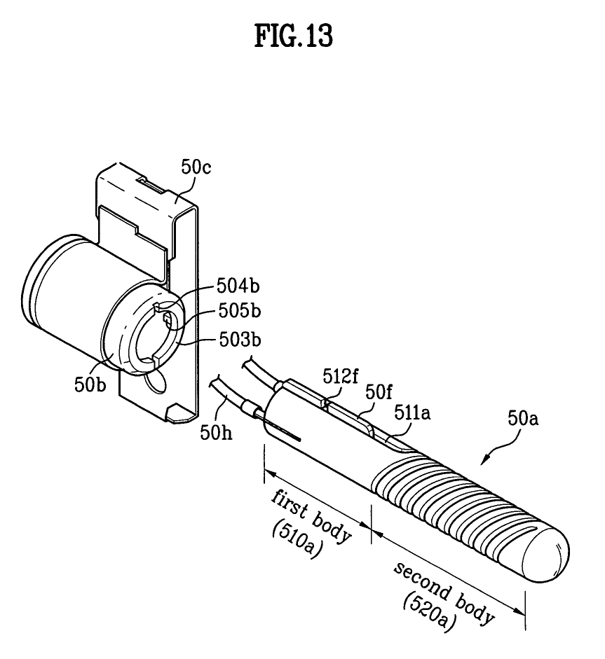

FIG. 13 illustrates a perspective view of an improved igniter in accordance with a seventh embodiment of the present invention.

Referring to FIG. 13, a stopper flange 503b projects inward of the bushing 50b from an end of the bushing 50b in contact with the igniter element 50a.

The stopper flange 503b has guide slots 504b at two points along a circumferential direction of the stopper flange 503b. The guide slots 504b guide the large width part 510f of the polarizing key 50f when the bushing 50b is inserted onto a side of the second body 520a of the igniter element 50a.

The polarizing key 50f has a bushing stopper slot 512f in each of opposite edges of the large width part 510f. The bushing stopper slots 512f allows insertion of the stopper flange 503b into the bushing stopper slot 512f when the bushing 50b is rotated after the bushing is inserted to a certain position. Once the stopper flange 503b is inserted into the bushing stopper slot 512f, the bushing 50b is firmly fixed to the igniter element 50a.

The bushing 50b may have a stopper projection 505b on an inside circumferential surface of the bushing 50b. The polarizing key 50f is caught at the stopper projection 505b when the bushing 50b is rotated such that the stopper flange 503b of the bushing 50b is positioned in the bushing stopper slots 512f, thereby preventing any further rotation of the bushing 50b.

According to the seventh embodiment of the present invention, as system vibration occurs when the igniter 50 is mounted with a slope such that a front side is higher than a rear side in a dryer having the igniter 50 of FIG. 13 applied thereto, the stopper flange 503b of the bushing 50b fitted to the bushing stopper slots 512f in the polarizing key 50f prevents the polarizing key 50f and the adhesive 50d joined therewith from slipping backward. Likewise, the break away of the igniter element 50a joined with the adhesive 50d from the bushing 50b can be prevented effectively at the end.

In summary, by forming the bushing stopper slots 512f in the polarizing key 50f and the stopper flange on the bushing 50b, the igniter element 50a can be fixed to the bushing 50b by interference between the stopper flange 503b and the bushing stopper slots 512f as the bushing 50b is turned when the bushing 50b is inserted to a certain position on the polarizing key 50f.

The seventh embodiment effectively prevents break away of the igniter element 50a from the bushing 50b regardless of the sloped or horizontal mounting of the igniter 50 when the igniter 50 is used with a dryer or the like.

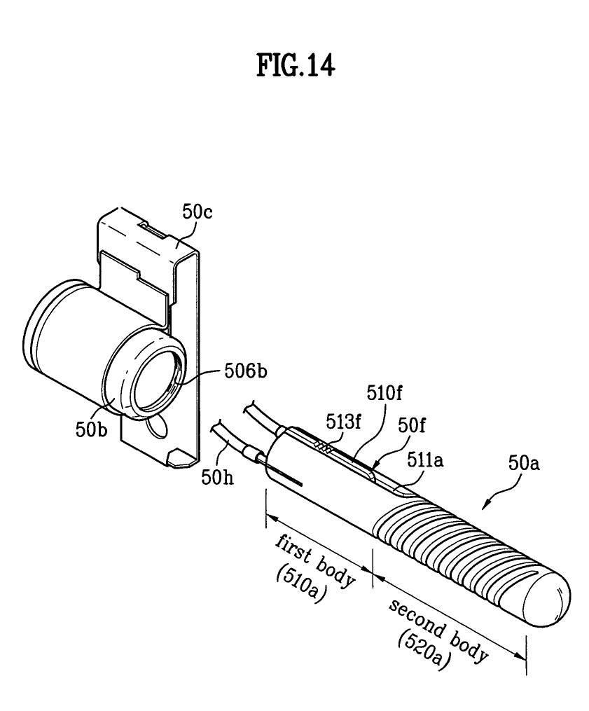

FIG. 14 illustrates a disassembled perspective view of an improved igniter in accordance with an eighth embodiment of the present invention. Referring to FIG. 14, a male thread is formed on the large width part 510f of the polarizing key 50f, and a female thread 506b is formed in an inside circumferential surface of the bushing 50b which complements the male thread in the large width part 510f.

According to the eighth embodiment of the present invention, since the bushing 50b is fastened with the polarizing key 50f using the previously described male and female threads when the bushing 50b is mounted on the igniter element 50a, even if vibration from the system is transmitted to the igniter 50, break away of the igniter element 50a is prevented.

As discussed with reference to the sixth embodiment, the eighth embodiment effectively prevents break away of the igniter element 50a from the bushing 50b regardless of the sloped or horizontal mounting of the igniter 50 when the igniter 50 is used with a dryer or the like.

Since the thread fastening between the bushing 50b and the polarizing key 50f prevents slip of the adhesive 50d joined with the polarizing key 50f in any direction, break away of the igniter element 50a from the bushing 50b is prevented at the end.

It is apparent that the igniters of the fourth to eighth embodiments as shown in FIGS. 10 to 14 can be embodied individually undoubtedly, or combined with the first to third embodiments.

Using the sealant 50e together with the structural changes of the bushing 50b and/or the polarizing key 50f enhances prevention of component break away of the igniter 50.

The technical aspects and systems shown in the first to eighth embodiments of the present invention are applicable to the other types of igniters shown in FIGS. 5A-5D.

Thus, the systems in accordance with different embodiments of the present invention for prevention of break away of the components of the igniter are applicable individually, or in combination, not only to igniters of a type in which the bracket 50c is fastened to the bushing 50, but also to igniters of a type in which the igniter has the bushing 50b fastened by separate means without the bracket 50c.

In the second to eighth embodiments, all materials that have a bonding force and heat resistance, such as silicone, epoxy resin, or EMC, may be used for the sealant 50e.

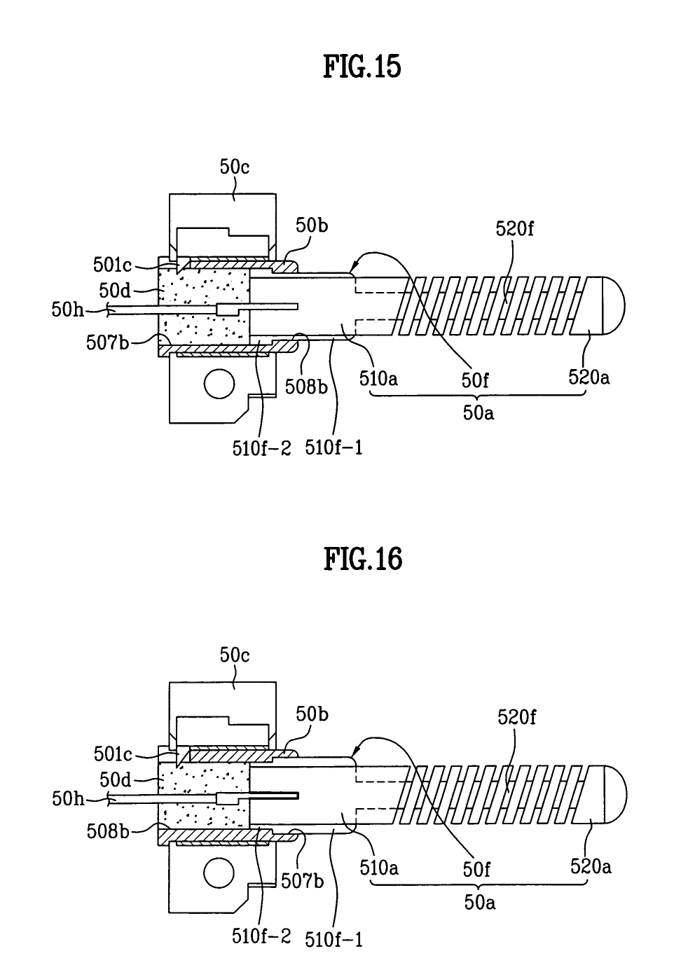

FIG. 15 illustrates a front view of an improved igniter in accordance with a ninth embodiment of the present invention.

Referring to FIG. 15, a step is formed in each of an inside circumferential surface of the bushing 50b and an outside circumferential surface of the polarizing key 50f. In more detail, the inside circumferential surface of the bushing 50b inserted on the first body 510a of the igniter element 50a has a large diameter part 507b and a small diameter part 508b. The large diameter part 507b is formed where a part of the adhesive 50d is placed therein, and the small diameter part 508b is formed in a part opposite to the part the adhesive is placed therein. This structure provides the step between the large diameter part 507b and the small diameter part 508b. The large width part 510f of the polarizing key has a first large width part 510f-1 and a second large width part 510f-2. The small diameter part 508b receives the first large width part 510f-1 when the first body 510a is inserted in the bushing 50b. The first large width part 510f-1 has a size equal to or slightly smaller than a diameter of the small diameter part 508b of the bushing 50b. The large diameter part 507b receives the second large width part 510f-2. The second large width part 510f-2 has a size equal to or slightly smaller than the large diameter part 507b.

The igniter 50 in accordance with a ninth embodiment of the present invention is provided with a structure for easy positioning of insertion of the bushing during fabrication of the igniter, and a structure for preventing the igniter element 50a from breaking away in a forward direction due to vibration.

The igniter 50 in accordance with a ninth embodiment of the present invention automatically fixes an inserting position of the bushing 50b by providing the step of the polarizing key 50f and inserting the bushing 50 into the igniter 50 from front to rear.

To further illustrate, as the large diameter part 507b of the bushing 50b is fit to the second large width part 510f-2 of the polarizing key 50f, the inserting position of the bushing 50b with respect to the polarizing key 50f is fixed, automatically. Thus, the easy positioning of the bushing during fabrication of the igniter 50 improves productivity.

Moreover, when an igniter has the foregoing structures, even if the bonding force of the adhesive 50d is weakened by vibration applied from an exterior for a period of time, a front direction break away of the igniter element 50a from the bushing is prevented.

FIG. 16 illustrates a front view of an improved igniter in accordance with a tenth embodiment of the present invention.

Referring to FIG. 16, a step is formed inside a circumferential surface of the bushing 50b and an outside circumferential surface of the polarizing key 50f. In more detail, the inside circumferential surface of the bushing 50b inserted on the first body 510a of the igniter element 50a has a large diameter part 507b and a small diameter part 508b. The small diameter part 508b is formed where a part of the adhesive 50d is placed therein, and the large diameter part 507b is formed in a part opposite to the part where the adhesive is placed. This structure provides the step between the large diameter part 507b and the small diameter part 508b. The large width part 510f of the polarizing key 50f has a first large width part 510f-1 and a second large width part 510f-2. The large diameter part 507b receives the first large width part 510f-1 when the first body 510a is inserted in the bushing 50b. The first large width part 510f-1 has a size equal to or slightly smaller than a diameter of the large diameter part 507b of the bushing 50b. The small diameter part 508b receives the second large width part 510f-2. The second large width part 510f-2 has a size equal to or slightly smaller than the small diameter part 508b.

As discussed with reference to the ninth embodiment, the igniter 50 in accordance with the tenth embodiment of the present invention has a structure for easy positioning and insertion of the bushing during fabrication of the igniter, and a structure for preventing the igniter element 50a from breaking away in a forward direction due to vibration.

The igniter 50 in accordance with a the tenth embodiment of the present invention fixes an inserting position of the bushing 50b automatically by providing the step of the polarizing key 50f and inserting the bushing 50 into the igniter 50 from rear to front.

As the large diameter part 507b of the bushing 50b is fit to the first large width part 510f-1 of the polarizing key 50f, the inserting position of the bushing 50b with respect to the polarizing key 50f is fixed, automatically. Thus, the easy positioning of the bushing in fabrication of the igniter 50 improves productivity.

Moreover, when an igniter has the foregoing structures, if the bonding force of the adhesive 50d is weakened by vibration from an exterior for a period of time, rear direction break away of the igniter element 50a from the bushing is prevented.

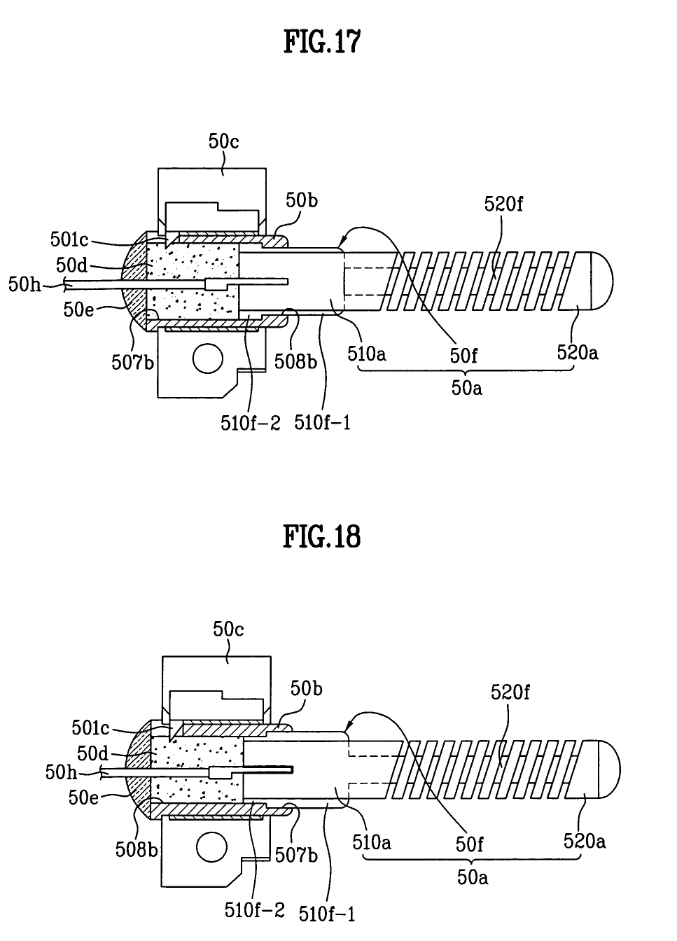

FIG. 17 illustrates a section of an improved igniter in accordance with an eleventh embodiment of the present invention. The eleventh embodiment has a structure similar to the ninth embodiment described with reference to FIG. 15 and includes the sealant 50e. The sealant 50e is coated on a surface of the bushing 50b in which the adhesive 50d is inserted thereby covering both the adhesive 50d and the bushing 50b. The sealant 50e may be any material having silicone or epoxy resin, EMC (Epoxy Molding Compound), or the like.

If the igniter has the foregoing structures, the igniter has all the advantages of the embodiment described with reference to FIG. 6 and the embodiment described with reference to FIG. 15. Description of the advantages, given already, will be omitted.

FIG. 18 illustrates an improved igniter in accordance with a twelfth embodiment of the present invention. The twelfth embodiment has the structure of the tenth embodiment described with reference to FIG. 16 and includes a sealant 50e. The sealant 50e is coated on a surface of the bushing 50b in which the adhesive 50d is inserted thereby covering both the adhesive 50d and the bushing 50b. The sealant 50e, may be any material having a bonding force and heat resistance such as silicone or epoxy resin, EMC (Epoxy Molding Compound), or the like.

If the igniter has the foregoing structures, the igniter has all the advantages of the embodiment described with reference to FIG. 6 and the embodiment described with reference to FIG. 16. Description of the advantages, given already, will be omitted.

The technical aspects and systems shown in the eleventh and twelfth embodiments of the present invention are applicable to other types of igniters, fully.

For example, the systems in accordance with different embodiments of the present invention which prevent break away of the components of the igniter are applicable individually, or in combination, not only to igniters of a type in which the bracket 50c is fastened to the bushing 50, but also to igniters of a type in which the igniter has the bushing 50b fastened by separate means without the bracket 50c.

Thus, the present invention can prevent break away of components of an igniter positively if vibration takes place at the system the igniter is mounted therein by applying sealant 50e for securing a bonding force between the components of the igniter, or by changing, or combining structures of the components of the igniter.

Also, the present invention can improve ease of assembly during fabrication of the igniter and prevent break away of components of an igniter if vibration takes place at the system of a dryer to which the igniter is mounted. This may be accomplished by changing structures of the components of the igniter to ease assembly of the components and applying sealant 50e to the igniter to secure a bonding force between the components.

It will be apparent to those skilled in the art that various modifications and variations can be made in the present invention without departing from the spirit or scope of the invention.

Embodiments described with reference to FIGS. 8-14 may be combined with the embodiments described with reference to FIGS. 15 and 16. Also, embodiments described with reference to FIGS. 10-14 may be combined with the embodiments described with reference to FIGS. 17 and 18.

Thus, it is intended that the present invention cover the modifications and variations of this invention provided they come within the scope of the appended claims and their equivalents.

What is claimed is:

1. An igniter comprising:
an igniter element having a polarizing key for generating heat at a high temperature;
a bushing inserted on an outside of one end of the igniter element;
adhesive placed in a cavity of the bushing for bonding the bushing with the one end of the igniter element; and
sealant covering both the bushing and the adhesive placed in the cavity of the bushing, the sealant joining the bushing and adhesive.

2. The igniter as claimed in claim 1, wherein the igniter element includes:
a cylindrical hollow first body having straight slots extending in a length direction;
a second body extending in a length direction from the cylindrical hollow first body, the second body having helical bands formed along a length direction of the second body starting from the slots; and
a polarizing key inserted in the first and second bodies, the polarizing key having a lead line connected thereto.

3. The igniter as claimed in claim 2, wherein the first and second bodies are formed of a non-metallic resistant material.

4. The igniter as claimed in claim 3, wherein the non-metallic resistant material is silicon carbide.

5. The igniter as claimed in claim 2, wherein the polarizing key further includes;
a large width part of a plate in the first body having a part exposed to an exterior through the slots; and
a small width part in the second body extending from the large width part.

6. The igniter as claimed in claim 1, the igniter further comprising a bracket fastened to an outside surface of the bushing.

7. The igniter as claimed in claim 1, wherein the sealant is one selected from the group consisting of silicone, epoxy, and EMC (Epoxy Molding Compound).

8. The igniter as claimed in claim 1, wherein the adhesive is ceramic cement.

9. The igniter as claimed in claim 1, wherein the sealant is coated on a side of the bushing opposite to a side the igniter element is in contact therewith, the sealant covering both the adhesive and the bushing.

10. The igniter as claimed in claim 1, wherein the sealant is coated on a side of the bushing contacting the igniter element such that the sealant covers both the bushing and an area of an outside circumferential surface of the igniter element.

11. The igniter as claimed in claim 1, wherein the adhesive is placed in a part of the cavity of the bushing, and the sealant is placed in the remainder of the cavity.

12. The igniter as claimed in claim 1, wherein the adhesive is placed in substantially one half of the cavity, and the sealant is placed in the remainder of the cavity.

13. The igniter as claimed in claim 1, wherein the bushing includes means for preventing the adhesive from moving in a length direction of the bushing and for increasing a bonding force with the adhesive.

14. The igniter as claimed in claim 13, wherein the means is an uneven surface formed in an inside circumferential surface of the bushing.

15. The igniter as claimed in claim 14, wherein the uneven surface has a dimple.

16. The igniter as claimed in claim 15, wherein the uneven surface has a lattice.

17. The igniter as claimed in claim 13, wherein the means is a flange extending inwardly from the bushing.

18. The igniter as claimed in claim 17, wherein the flange is formed at a side of the bushing opposite a side in contact with the igniter element.

19. The igniter as claimed in claim 1, the igniter further comprising means for preventing the igniter element from moving in a length direction with respect to the bushing.

20. The igniter as claimed in claim 19, wherein the means includes:
key slots in an outside surface of the polarizing key; and
a snap ring inserted on an outside circumference of the igniter element such that the snap ring contacts the bushing when the snap ring is inserted in the key slots thereby preventing the igniter element from moving toward the bushing.

21. The igniter as claimed in claim 20, wherein the snap ring is formed of a non-metallic material.

22. The igniter as claimed in claim 19, wherein the means includes:
a stopper flange disposed on the bushing, the stopper flange projecting inwardly from a side the bushing is in contact with the igniter;
guide slots in the stopper flange, the guide slots guiding opposite side surfaces of the polarizing key when the bushing is inserted in the igniter element; and
bushing stopper slots, the bushing stopper slots receiving the stopper flange to limit a length direction movement of the bushing and the igniter element when the bushing is turned after the igniter element is inserted in the bushing.

23. The igniter as claimed in claim 22, wherein the means includes a stopper projection for limiting a rotation angle of the bushing when the bushing is rotated when the stopper flange is inserted in the bushing stopper slots.

24. The igniter as claimed in claim 19, wherein the means includes:
a male thread formed in an outside circumferential surface of the polarizing key; and
a female thread on an inside circumferential surface of the bushing for engaging with the male thread in the polarizing key.

25. The igniter as claimed in claim 19, wherein the means includes:
a step on an inside circumferential surface of the bushing; and
a step on an outside circumferential surface of the polarizing key where the polarizing key step engages with the step on the bushing thereby preventing the igniter element from moving toward any side of a length direction of the igniter.

26. The igniter as claimed in claim 25, wherein the bushing is fastened to the igniter element as the bushing is inserted from a fore end of the igniter element to a rear end of the igniter element to which a lead line is connected.

27. The igniter as claimed in claim 26, wherein the step on the bushing is formed at a boundary surface between a small diameter part formed on an inside circumferential surface of the bushing at a side of the bushing where a rear end of the igniter element is in direct contact therewith, and a large diameter part formed on the inside circumferential surface of the bushing so as to be in contact with the small diameter part where the step on the polarizing key is formed at a boundary surface between a first large width part in contact with the small diameter part at rear end side of the igniter element and a second large width part on the outside circumferential surface of the polarizing key so as to be in contact with the large diameter part.

28. The igniter as claimed in claim 25, wherein the bushing is inserted from a rear end of the igniter element to a fore end of the igniter element.

29. The igniter as claimed in claim 28, wherein the step on the bushing is formed at a boundary surface between a large diameter part formed on an inside circumferential surface of the bushing at a side of the bushing in direct contact with a rear end of the igniter element, and a small diameter part formed on the inside circumferential surface of the bushing so as to be in contact with the large diameter part, where the step on the polarizing key is formed at a boundary surface between a first large width part in contact with the large diameter part at rear end side of the igniter element and a second large width part on the outside circumferential surface of the polarizing key so as to be in contact with the small diameter part.

30. An igniter comprising:
an igniter element having a polarizing key for generating heat at a high temperature;
an adhesive; and
a bushing inserted on an outside of an end of the igniter element, the bushing having means for preventing the adhesive from moving along a length direction to increase joining force with the adhesive wherein the adhesive is placed in a cavity of the bushing for bonding the bushing with the one end of the igniter element.

31. The igniter as claimed in claim 30, wherein the igniter element includes:
a cylindrical hollow first body having straight slots extending in a length direction;
a second body extending in a length direction from the cylindrical hollow first body, the second body having helical bands formed along a length direction of the second body starting from the slots; and
a polarizing key inserted in the first and second bodies, the polarizing key having a lead line connected thereto.

32. The igniter as claimed in claim 31, wherein the polarizing key further includes:
a large width part of a plate in the first body having a part exposed to an exterior through the slots; and
a small width part in the second body extending from the large width part.

33. The igniter as claimed in claim 30, further comprising a bracket fastened to an outside surface of the bushing.

34. The igniter as claimed in claim 30, wherein the means is an uneven surface formed in an inside circumferential surface of the bushing.

35. The igniter as claimed in claim 34, wherein the uneven surface has a dimple.

36. The igniter as claimed in claim 34, wherein the uneven surface has a lattice.

37. The igniter as claimed in claim 30, wherein the means is a flange extending inwardly from the bushing.

38. The igniter as claimed in claim 37, wherein the flange is formed at a side of the bushing opposite a side in contact with the igniter element.

39. An igniter comprising:
an igniter element having a polarizing key for generating heat at a high temperature;
a bushing inserted on an outside of one end of the igniter element;
an adhesive placed in a cavity of the bushing, the adhesive bonding the bushing with the one end of the igniter element; and
a means for preventing movement of the igniter element in a length direction with respect to the bushing.

40. The igniter as claimed in claim 39, wherein the igniter element includes:
a cylindrical hollow first body having straight slots extending in a length direction;
a second body extending in a length direction from the cylindrical hollow first body part, the second body having helical bands formed along a length direction of the second body starting from the slots; and
a polarizing key inserted in the first and second bodies, the polarizing key having a lead line connected thereto.

41. The igniter as claimed in claim 40, wherein the first and second bodies are formed of a non-metallic resistant material.

42. The igniter as claimed in claim 39, further comprising a bracket fastened to an outside surface of the bushing.

43. The igniter as claimed in claim 39, wherein the means includes:
key slots in an outside surface of the polarizing key; and
a snap ring inserted on an outside circumference of the igniter element such that the snap ring contacts the bushing when the snap ring is inserted in the key slots in contact with the bushing thereby preventing the igniter element from moving toward the bushing.

44. The igniter as claimed in claim 39, wherein the means includes:
a stopper flange on the bushing, the stopper flange projecting inwardly from a side of the bushing in contact with the igniter;
guide slots disposed in the stopper flange, the guide slots guiding opposite side surfaces of the polarizing key when the bushing is inserted in the igniter element; and
bushing stopper slots, the bushing stopper slots receiving the stopper flange when the bushing is turned after the igniter element is inserted in the bushing thereby limiting a length direction movement of the bushing and the igniter element.

45. The igniter as claimed in claim 44, wherein the means includes a stopper projection for limiting a rotation angle of the bushing when the bushing is rotated as the stopper flange is inserted in the bushing stopper slots.

46. The igniter as claimed in claim 39, wherein the means includes:
a male thread formed in an outside circumferential surface of the polarizing key; and
a female thread on an inside circumferential surface of the bushing, the female thread engaging with the male thread in the polarizing key.

47. The igniter as claimed in claim 39, wherein the means includes:
a step on an inside circumferential surface of the bushing; and
a step on an outside circumferential surface of the polarizing key so as to be engaged with the step on the bushing for preventing the igniter element from moving toward any side of a length direction.

48. The igniter as claimed in claim 47, wherein the bushing is fastened to the igniter element as the bushing is inserted from a fore end of the igniter element to a rear end of the igniter element to which a lead line is connected.

49. The igniter as claimed in claim 48, wherein the step on the bushing is formed at a boundary surface between a small diameter part formed on an inside circumferential surface of the bushing at a side of the bushing where a rear end of the igniter element is in direct contact therewith, and a large diameter part formed on the inside circumferential surface of the bushing so as to be in contact with the small diameter part where the step on the polarizing key is formed at a boundary surface between a first large width part in contact with the small diameter part at rear end side of the igniter element and a second large width part on the outside circumferential surface of the polarizing key so as to be in contact with the large diameter part.

50. The igniter as claimed in claim 47, wherein the bushing is inserted from a rear end of the igniter element to a fore end of the igniter element.

51. The igniter as claimed in claim 50, wherein the step on the bushing is formed at a boundary surface between a large diameter part formed on an inside circumferential surface of the bushing at a side of the bushing where a rear end of the igniter element is in direct contact therewith, and a small diameter part formed on the inside circumferential surface of the bushing so as to be in contact with the large diameter part where the step on the polarizing key is formed at a boundary surface between a first large width part in contact with the large diameter part at rear end side of the igniter element and a second large width part on the outside circumferential surface of the polarizing key so as to be in contact with the small diameter part.

52. The igniter as claimed in claim 47, further comprising sealant coated on a side of the bushing opposite to a side the igniter element contacts the bushing, to cover both the adhesive and the bushing.

53. The igniter as claimed in claim 47, further comprising sealant coated on a side of the bushing which contacts the igniter element, to cover both the bushing and an area of an outside circumferential surface of the igniter element.

54. The igniter as claimed in claim 52, wherein the adhesive is placed in a part of the cavity of the bushing, and the sealant is placed in a remainder of the cavity.

55. The igniter as claimed in claim 52, wherein the adhesive is placed in substantially one half of the cavity, and the sealant is placed in a remainder of the cavity.

56. A dryer comprising:
a cabinet;
a drum rotatably mounted in the cabinet for holding a drying object; and
a burner inside of the cabinet for generating heated air, the burner having an igniter for igniting fuel supplied from an exterior, the igniter including:
an igniter element having a polarizing key for generating heat at a high temperature;
a bushing inserted on an outside of one end of the igniter element;
adhesive placed in a cavity of the bushing for bonding the bushing with the one end of the igniter element; and
sealant covering both the bushing and the adhesive placed in the cavity of the bushing for joining the bushing and adhesive.

57. The dryer as claimed in claim 56, wherein the sealant is coated on a side of the bushing opposite to a side of the bushing in contact with the igniter element thereby covering both the adhesive and the bushing.

58. The dryer as claimed in claim 56, wherein the sealant is coated on a side of the bushing which contacts the igniter element thereby covering both the bushing and an area of an outside circumferential surface of the igniter element.

59. The dryer as claimed in claim 56, wherein the adhesive is placed in a part of the cavity of the bushing, and the sealant is placed in a remainder of the cavity.

60. The dryer as claimed in claim 56, wherein the adhesive is placed in substantially one half of the cavity, and the sealant is placed in a remainder of the cavity.

61. The dryer as claimed in claim 56, wherein the sealant is one selected from the group consisting of silicone, epoxy, and EMC.

62. The dryer as claimed in claim 56, wherein the bushing includes an uneven surface formed in an inside circumferential surface.

63. The dryer as claimed in claim 56, wherein the bushing further includes a flange part projecting inwardly from a surface which contacts the igniter element.

64. The dryer as claimed in claim 56, wherein the igniter includes:
key slots in an outside surface of the polarizing key; and
a snap ring inserted on an outside circumference of the igniter element such that the snap ring contacts the bushing when the snap ring is inserted in the key slots in contact with the bushing thereby preventing the igniter element from moving toward the bushing.

65. The dryer as claimed in claim 56, wherein the igniter includes:
a stopper flange disposed on the bushing, the stopper flange projecting inwardly from a side the bushing is in contact with the igniter;
guide slots in the stopper flange, the guide slots guiding opposite side surfaces of the polarizing key when the bushing is inserted in the igniter element, and
bushing stopper slots, the bushing stopper slots receiving the stopper flange to limit a length direction movement of the bushing and the igniter element when the bushing is turned after the igniter element is inserted in the bushing.

66. The dryer as claimed in claim 65, wherein the igniter further includes a stopper projection for limiting a rotation angle of the bushing when the bushing is rotated when the stopper flange is inserted in the bushing stopper slots.

67. The dryer as claimed in claim 56, wherein the igniter further includes:
a male thread formed in an outside circumferential surface of the polarizing key; and
a female thread on an inside circumferential surface of the bushing for engaging with the male thread in the polarizing key.

68. The dryer as claimed in claim 56, wherein the igniter further includes:
a step on an inside circumferential surface of the bushing; and
a step on an outside circumferential surface of the polarizing key where the polarizing key step engages with the step on the bushing thereby preventing the igniter element from moving toward any side of a length direction of the igniter.

69. An igniter, the igniter comprising:
an igniter element;
a bushing disposed adjacent the igniter element; and
an adhesive, the adhesive being disposed within the bushing, the adhesive bonding with both the bushing and the igniter such that the adhesive bonds both the bushing and the igniter element.

70. An igniter as recited in claim 69, the igniter element further comprising:
a first body; and
a second body opposite the first body wherein the first body is adjacent the bushing.

71. An igniter as recited in claim 70, the bushing further comprising:
a cavity wherein a portion of the igniter first body is disposed within the cavity.

72. An igniter as recited in claim 71, wherein the adhesive is substantially disposed within the bushing cavity.

73. An igniter as recited in claim 72, the igniter further comprising:
a sealant, the sealant being disposed on an end of the bushing where the sealant grips both the adhesive and the bushing such that the sealant maintains the position of the igniter element.

74. An igniter as recited in claim 73, wherein the sealant is disposed on an end of the bushing opposite the igniter first body.

75. An igniter as recited in claim 72, the igniter further comprising:
a sealant, the sealant being disposed on an end of the bushing which contacts the igniter element such that the sealant grips both the bushing and the igniter element thereby maintaining the position of the igniter element.

76. An igniter as recited in claim 70, the bushing further comprising:
an inside circumferential surface having an uneven surface where the adhesive is substantially disposed within the bushing inside circumferential surface.

77. An igniter as recited in claim 72, the bushing further comprising:
a flange disposed at an end of the bushing opposite the igniter first body wherein the adhesive is substantially disposed within the bushing between the igniter first body and the bushing flange.

78. An igniter as recited in claim 72, the igniter element further comprising:
a polarizing key, the polarizing key having:
a large width part; and
a key slot;
a snap ring disposed on the key slot.

79. An igniter as recited in claim 78, the igniter further comprising:
a stopper flange, the stopper flange projecting inward from an end of the bushing adjacent the igniter element, the stopper flange engaging with a bushing stopper slot of the polarizing key.

80. An igniter as recited in claim 79, the stopper flange further comprising:
a stopper projection disposed along a circumference of the stopper flange, the stopper projections limiting a rotation angle when the stopper flange engages with the bushing stopper slot; and
a guide slot disposed along the circumference of the stopper flange wherein the guide slots guide the polarizing key large width part.

81. An igniter as recited in claim 78, the bushing further comprising:
female threads disposed within an inner circumference of the bushing cavity.

82. An igniter as recited in claim 81, the polarizing key further comprising:
male threads disposed on the polarizing key large width part wherein the male threads complement the bushing female threads.

83. An igniter as recited in claim 78, the bushing further comprising:
a small diameter portion within the bushing cavity; and
a large diameter portion within the bushing cavity adjacent the small diameter bushing such that the small diameter portion and the large diameter portion form a step within the bushing cavity.

84. An igniter as recited in claim 83, wherein the adhesive is disposed within the bushing large diameter portion.

85. An igniter as recited in claim 84, wherein the polarizing key large width part includes a first large width part and a second large width part adjacent the first large width part where the first large width part engages with the bushing small diameter portion and the second large width part engages with the bushing large diameter portion.

86. An igniter as recited in claim 85, the igniter further comprising:
a sealant, the sealant being disposed on an end of the bushing where the sealant grips both the adhesive and the bushing such that the sealant maintains the position of the igniter element.

87. An igniter as recited in claim 83, wherein the adhesive is disposed within the bushing small diameter portion.

88. An igniter as recited in claim 87, wherein the polarizing key large width part includes a first large width part and a second large width part adjacent the first large width part such that the first large width part engages with the bushing large diameter portion and the second large width part engages with the bushing small diameter portion.

89. An igniter as recited in claim 88, the igniter further comprising:
a sealant, the sealant being disposed on an end of the bushing where the sealant grips both the adhesive and the bushing wherein the sealant maintains the position of the igniter element.

90. A method of maintaining a position of an igniter during operation, the igniter having an igniter element, a bushing with a cavity, and an adhesive, the method comprising:
placing the bushing over a first end of the igniter element such that the first end of the igniter element is substantially within the bushing cavity; and
bonding the bushing with igniter wherein the adhesive is placed within the bushing cavity such that the adhesive bonds with both the bushing and the igniter element thereby maintaining the position of the igniter during operation.

91. A method of maintaining a position of an igniter as recited in claim 90, the method further comprising:
attaching a sealant at an end of the bushing such that the sealant grips both the adhesive and the bushing, thereby maintaining the position of the igniter during operation.

92. A method of maintaining a position of an igniter as recited in claim 90, wherein the igniter element includes:
a polarizing key, the polarizing key having:
a large width part; and
bushing stopper slots.

93. A method of maintaining a position of an igniter as recited in claim 92, wherein the bushing includes an inwardly projecting stopper flange, the stopper flange having:
guide slots disposed along a circumference of the stopper flange; and
stopper projections, the stopper projections being disposed along the stopper flange circumference.

94. A method of maintaining a position of an igniter as recited in claim 93, the operation of placing the bushing over a first end of the igniter further comprising:
guiding the polarizing key large width part with the guide slot; and
engaging the stopper projections with the bushing stopper slots of the polarizing key.

95. A method of maintaining a position of an igniter as recited in claim 92, wherein the bushing includes a step formed by a small diameter part disposed within the bushing cavity and a large diameter part disposed within the bushing cavity adjacent the small diameter part.

96. A method of maintaining a position of an igniter as recited in claim 95, wherein the polarizing key large width part includes a first large width part and a second large width part adjacent the first large width part.

97. A method of maintaining a position of an igniter as recited in claim 96, the operation of placing the bushing over a first end of the igniter further comprising:
inserting the bushing over the igniter element from a fore end of the igniter element to a rear end of the igniter element.

98. A method of maintaining a position of an igniter as recited in claim 96, the operation of placing the bushing over a first end of the igniter further comprising:
inserting the bushing over the igniter element from a rear end of the igniter element to a fore end of the igniter element.
